(19) United States
(12) Patent Application Publication
(10) Pub. No.: US 2026/0110369 A1
(43) Pub. Date: Apr. 23, 2026

(54) VALVE CONTROL FOR CONTROLLING A SOLENOID VALVE, VALVE ARRANGEMENT AND METHOD FOR OPERATING A SOLENOID VALVE

(71) Applicant: Festo SE & Co. KG, Esslingen (DE)

(72) Inventors: Jens ENGELHARDT, Esslingen (DE); Tobias WATZER, Deizisau (DE)

(21) Appl. No.: 19/317,633

(22) Filed: Sep. 3, 2025

(30) Foreign Application Priority Data
Sep. 4, 2024 (DE) 10 2024 125 303.7

(51) Int. Cl. F16K 31/06; F16K 31/04

(52) U.S. Cl. CPC F16K 31/0675; F16K 31/046

(57) ABSTRACT

A valve control for controlling a solenoid valve, with a controller which has an input interface for receiving a switching signal and an output interface for coupling a solenoid valve and which is designed to process the switching signal and to supply a coil current dependent on the switching signal to the output interface. The controller is designed to regulate the coil current to an pull-in current during a first time period and to regulate the coil current to a holding current which is less than 70 percent of the pull-in current during a subsequent second time period, and to increase the holding current by at least 20 percent for a limited period of time during the second period when a predetermined coil current threshold value is exceeded.

### CROSS-REFERENCE TO RELATED APPLICATION

This application claims priority to German application 102024125 303.7, filed September 4, 2024, which is incorporated herein by reference.

### BACKGROUND OF THE INVENTION

The invention relates to a valve control for controlling a solenoid valve, a valve arrangement and a method for operating a solenoid valve.

WO2017045701A1 discloses a valve control for the electrical control of at least one valve actuator, with a control circuit that is designed to influence an electrical energy flow between an electrical source and the valve actuator and that comprises a bus interface for communication with a higher-level control arrangement and a sensor means which is designed to determine a physical variable of the energy flow that can be changed by electrical control of the valve actuator and to provide a sensor signal dependent on the determined physical variable to the control circuit, wherein the control circuit is designed to determine a status value for the valve actuator on the basis of the sensor signal and at least one characteristic value of a physical quantity from the group consisting of: energy flow duration, energy flow voltage, energy flow current, fluid pressure, and to supply the status value to the bus interface.

### SUMMARY OF THE INVENTION

The object of the invention is to provide a valve control for controlling a solenoid valve, a valve arrangement, and a method for operating a solenoid valve, with which a predetermined switching state of the solenoid valve can be maintained with high energy efficiency even when external disturbance factors are taken into account.

This task is solved for a valve control for controlling a solenoid valve by that the valve control has a controller, which controller has an input interface for receiving a switching signal and an output interface for coupling a solenoid valve which controller processes the switching signal and supplies a coil current dependent on the switching signal to the output interface, wherein the controller regulates (closed loop) the coil current to an pull-in current during a first time period and regulates the coil current to a holding current during a subsequent second time period, which holding current is less than 70 percent of the pull-in current, wherein the controller increases the holding current for a limited time by at least 20 percent, preferably by at least 30 percent, in particular by at least 40 percent during the second period, when a predetermined coil current threshold value is exceeded.

The valve control can be designed to control a single solenoid valve or a group of solenoid valves and comprises, in addition to the controller, further electrical or electronic components. With these components, for example, an electrical supply voltage provided at a supply interface of the valve control can be influenced in a suitable manner and made available for supplying the controller and the at least one solenoid valve connectable to the valve control. An example of such a component is an electrical output stage which can be controlled by the controller with a control signal and which is designed to release electrical energy to the solenoid valve depending on a switching signal provided to the controller via an input interface. The switching signal may be a simple (analog or digital) on/off-signal which is provided from a higher-level machine control like a programmable logic control (PLC) to the input interface. The control signal, which is provided from the controller to the output stage is an analog or digital proportional signal. It is preferably provided that the input interface and the supply interface are designed as a common interface to which a plug connector can be connected, which is designed as part of a cable connection of the valve control to the higher-level machine control. Alternatively, the input interface and the supply interface may be designed for electrical plug connection to a base plate of a valve island, which base plate may have several slots for coupling valve controls.

The controller may, for example, be a microcontroller or a microprocessor, wherein the microcontroller or a microprocessor processes a computer program. This computer program is used to evaluate incoming switching signals, to provide control signals to one or more output stages of the valve control, to process sensor signals, and to regulate (control – closed loop) a coil current that is supplied to the connected solenoid valve. Alternatively, the controller is implemented as an analog circuit with discrete electrical components.

To perform current control, the controller is equipped with a sensor or a sensor arrangement or is electrically connected to a sensor or sensor arrangement. For example, a current sensor is provided, which is arranged in a connecting line between the electrical output stage and the solenoid valve, wherein this current sensor provides a sensor signal that is proportional to the current flow between the output stage and the solenoid valve. This sensor signal is processed in the controller to carry out the desired control (closed loop) of the coil current.

The controller is designed to provide the solenoid valve with electrical energy that varies over time in order to enable the solenoid valve to operate with high energy efficiency. For this purpose, the controller is designed to first provide a high coil current with a current strength referred to as the pull-in current strength in order to transfer a valve member of the solenoid valve from a first operating position to a second operating position. According to an embodiment of the invention, the first operating position may be a position of the valve member, in which a valve seat is closed by the valve member to interrupt a fluid flow in a fluid channel, in which the valve member and the valve seat are located. The second operating position may be a position of the valve member, in which the valve member is located in a distance to the valve seat to allow a fluid flow in a fluid channel. According to an alternative embodiment of the invention, the first operating position may be a position of the valve member, in which the valve member is located in a distance to a valve seat to allow a fluid flow in a fluid channel, in which the valve member and the valve seat are located. The second operating position may be a position of the valve member, in which the valve seat is closed by the valve member to interrupt a fluid flow in the fluid channel. As soon as the valve member, which is at least partially surrounded by a solenoid coil of the solenoid valve, has been transferred from the first operating position, which can also be referred to as the rest position, since the valve member rests in this position without a coil current, to the second operating position, which can be referred to as the active position, the coil current is reduced to a current referred to as the holding current. This holding current is less than 70 percent of the pull-in current and is selected so that the valve member can be held in the second operating position. The controller comprises a storage to store predetermined current values for the pull-in current and the holding current, which currents are used to regulate the coil current during the respective operating phase (pull-in phase and holding phase).

However, external magnetic fields may be coupled into the solenoid coil of the solenoid valve or accelerations may act on the valve element, which is functionally coupled to the solenoid coil, which may cause a change in the coil current flowing in the solenoid coil. For example, the coupling of an external magnetic field into the solenoid coil may cause an increase in the current flow in the solenoid coil, which causes the controller to reduce the coil current during the regulation of the coil current, since it is the task of the controller to provide an at least almost constant coil current to the solenoid coil. . This can cause, especially during the hold phase, due to a time lag or dead time of the controller to an unwanted decrease of the coil current, which may result in an undesired movement of the valve element from the second function position to the first function position. This leads to a malfunction of the solenoid valve, since the holding current is not sufficient to return the valve element from the first operating position to the second operating position, and the controller is not aware of the fact that the valve element has unexpectedly left the second operating position and has returned to the first operating position. A similar situation can occur if an external acceleration acts on the solenoid valve, causing the valve member to move from the second operating position to the first operating position without the controller being able to prevent this undesirable movement of the valve member by regulating the coil current to the holding current, if there is no special procedure to handle this situation.

Accordingly, in order to prevent such undesirable changes in the functional state of the solenoid valve, the controller monitors the coil current with regard to exceeding a specified threshold value In particular during the second time period, also referred to as the holding phase, during which the coil current is regulated to the holding current, this monitoring is executed in addition to regulating the coil current,. If the specified threshold value is exceeded, the controller is designed to increase the holding current by at least 20 percent for a limited period of time in order to prevent the valve element from moving undesirably from the second operating position to the first operating position. The time-limited increase of the coil current is realized by providing a respective control value to the controller, wherein this control value may be calculated from the standard holding current or may be retrieved from a storage which is connected with the controller or is part of the controller. In any case, the time-limited increase of the coil current is still related with the closed loop control of the coil current and is not just a provision of the maximum electrical supply voltage to the coil.

The time limit for increasing the holding current ensures that, if the specified coil current threshold value is exceeded, the controller increases the holding current for a specified period of time, whereby the coil current resulting from the increase in the holding current by at least 20 percent is referred to, for example, as the safety current. After the specified time period has elapsed, the controller restores the holding current to the solenoid coil. If, after the specified time period has elapsed and the supply of the safety current has been terminated, a coil current is detected that is again above the coil current threshold value, the controller is designed to again increase the holding current to the safety current for a limited period of time. If, after the specified time period has elapsed, a coil current below the coil current threshold value is detected, the controller supplies the holding current.

It is preferred that the coil current is also regulated by the controller during the time-limited increase of the holding current to the level of the safety current. It is particularly preferred that the percentage increase in the holding current strength can be specified during parameterization of the controller, thereby allowing adaptation to different operating conditions for the valve control and the at least one solenoid valve controlled by the valve control. The parameterization of the controller may be carried out during an initial programming of the controller. Alternatively or additionally the parameterization may be carried out by a user with a programming tool or by means of a data transfer from a higher level control to allow an adaptation of the controller to the specific use case for the valve control.

Advantageous further developments of the invention are the subject of the subclaims.

It is advantageous if the temporary increase in the holding current is carried out during a period of less than 0.5 seconds, preferably less than 0.3 seconds, and in particular less than 0.15 seconds. By limiting the increase in the holding current to a period of less than 0.5 seconds, most of the disturbances that can affect a solenoid valve are controlled without causing an undesirable shift of the valve element from the second operating position to the first operating position. Such disturbances can be, in particular, external magnetic fields or accelerations acting on the solenoid valve.

It is preferred that the controller is designed as an analog electrical circuit with discrete components.

In an alternative further development of the invention, the controller is designed to include a microcontroller that is set up to regulate the coil current during the first time period and during the second time period. In this case the controller is set up in such a way that the percentage increase for the holding current is determined during a parameterization of the controller in order to enable the at least one solenoid valve controlled by the valve control to be adapted to different operating conditions.

According to a second aspect of the invention, the task is solved by a valve arrangement comprising at least two solenoid valves and at least one valve control according to the invention, each solenoid valve having a valve housing through which a fluid channel extends between an inlet connection and an outlet connection and in which a valve member is arranged, which is movably received in the fluid channel between a first operating position and a second operating position, wherein a magnetic drive is arranged in the valve housing, which is designed to initiate movement of the valve member and is electrically connected to the valve control.

It is preferably provided that the valve housing of the solenoid valve is designed both for fluid guidance and for accommodating the magnetic drive. In this case, the valve housing, which is made in particular of plastic, has a fluid channel which extends between an inlet connection and an outlet connection and in which a movably mounted valve member is arranged. Depending on the design of a valve seat arranged in the fluid channel and the valve member, this may be a seat valve (at least essentially axially sealing) or a slide valve (at least essentially radially sealing) or a combination of a seat valve and a slide valve. If the valve member is designed as a slide valve, the valve housing may also have several fluid channels which, depending on the position of the valve member along an axis of movement, can be connected to or separated from each other in different fluidic interconnections.

By way of example, it is envisaged that the valve member can be moved from a first operating position into the second operating position by means of the solenoid drive against the restoring force of a return spring. For this movement of the valve member from the first operating position to the second operating position, the pull-in current must be supplied to the solenoid drive, since this movement first requires overcoming the static friction between the valve member and the fluid channel when the valve member is at rest, as well as the inertia of the valve member. Furthermore, after the valve member has started to move, the sliding friction between the valve member and the fluid channel must be overcome and the deformation energy for the elastic deformation of the return spring must be applied. As soon as the valve member has reached the second operating position and has come to rest there, the second time period begins, during which the controller can reduce the coil current of the solenoid drive to the holding current. In the second operating position, the restoring force of the return spring and, if applicable, any flow forces exerted on the valve member by a fluid flowing through the fluid channel must be compensated by the solenoid drive.

The solenoid drive comprises at least one solenoid coil, but may also comprise an arrangement of several solenoid coils. By supplying a coil current to the at least one solenoid coil, a magnetic flux is provided with which, for example, an armature made of a magnetically conductive material, such as iron, and which is movement-coupled to the valve member, can be moved. Depending on the design of the magnetic drive, the armature can perform a linear movement or a swivel movement. For example, the magnetic coil has a circular sleeve shape, and a first armature part is fixed in a central recess of the magnetic coil, and a second armature part, which is axially adjacent to the first armature part, is movably received in the central recess and can be moved linearly along a coil axis depending on the coil current in the magnetic coil. The armature part can also be equipped with one or more permanent magnets, which also enter into magnetic interaction with the magnetic flux of the magnetic coil.

If external disturbances cause a brief increase in the coil current, which could lead to a reduction in the coil current due to the controller's regulating action, with the risk of the valve element being undesirably transferred from the second operating position to the first operating position, the controller according to the invention can provide a counteraction by monitoring the coil current for exceeding the specified coil current threshold value, thereby preventing this undesirable movement of the valve element. In this case, the reduction in coil current that would normally be required to maintain the holding current due to the increased coil current caused by external magnetic field coupling or mechanical acceleration is replaced by a temporary increase in the holding current of at least 20 percent. In particular this temporary increase is still provided by a closed loop control of the holding current. This prevents the valve member from being transferred from the second operating position to the first operating position.

In an advantageous further development of the invention, two or more solenoid valves are accommodated in a common valve housing, the valve housing being provided with a number of input connections, output connections, fluid channels, and valve members corresponding to the number of solenoid valves.

It is preferred that each of the solenoid valves is assigned a valve control. The individual assignment of a valve control to each solenoid drive of each solenoid valve enables particularly advantageous control of the respective solenoid drive. This applies in particular in the case where individual adaptation of the valve control to the respective solenoid drive is provided anyway, for example by parameterization. This parameterization may be executed by a user and allows an individual adaptation of each of the valve controls to the specific use case.

In a further embodiment of the valve arrangement, the solenoid valves are arranged adjacent to one another, in particular with direct physical contact between the respective valve housings, along a row axis. Such an arrangement of solenoid valves, as is used in particular in valve islands for industrial automation or for laboratory automation, enables a particularly compact arrangement of the solenoid valves. For example, it is provided that the valve housings of the solenoid valves are of a cuboid shape, with the largest surface of each valve housing adjoining the largest surface of an adjacent valve housing. This results in the solenoid valves being arranged in a row along a row axis, with the spatial extension of the valve housings in the direction of the row axis being considerably smaller than in the spatial direction perpendicular to this row axis.

It is preferred that the solenoid valves of the valve arrangement are arranged on a common channel plate. For example, it is provided that at least one supply channel for supplying a gaseous fluid, in particular compressed air, to the solenoid valves is formed in the channel plate and each of the valve housings has an interface for sealingly coupling to the supply channel. In addition, an exhaust channel for discharging the gaseous fluid, in particular compressed air, from the respective solenoid valves may be provided in the channel plate. Furthermore, the channel plate may also be designed with plug connectors for supplying power to the controller and/or for providing control signals to the drive circuit.

The task of the invention is solved according to a third aspect of the invention by a method for operating a solenoid valve, which comprises the following steps: regulating a coil current for a solenoid coil during a first time period to a first coil current level in order to provide a first magnetic flux to a valve member and thereby move the valve member from a first operating position to a second operating position, regulating the coil current for the solenoid coil during a second time period to a second coil current level which is at most 70 percent of the first coil current level in order to supply a second magnetic flux to the valve member and thereby to hold the valve member in the second operating position, monitoring the coil current supplied to the solenoid coil during the second time period for exceeding a predetermined coil current threshold value and performing a time-limited increase of the second coil current level by at least 20 percent, preferably by at least 30 percent, in particular by at least 40 percent if the specified coil current threshold value is exceeded.

In a further development of the method, it is envisaged that the temporary increase in the holding current strength is carried out during a period of less than 0.5 seconds, preferably less than 0.3 seconds, in particular less than 0.15 seconds.

### BRIEF DESCRIPTION OF THE DRAWINGS

An advantageous embodiment of the invention is shown in the drawing. Here,

FIG. 1 shows a strictly schematic representation of a solenoid valve system with a solenoid valve designed as a diaphragm valve and an associated valve control,

FIG. 2 shows a strictly schematic representation of the essential functional components of the valve control,

FIG. 3 is a strictly schematic representation of a current-time diagram, and

FIG. 4 is a strictly schematic representation of a valve arrangement with several solenoid valves, each of which has a valve control and which are arranged on a common channel plate along a row axis.

### DETAILED DESCRIPTION

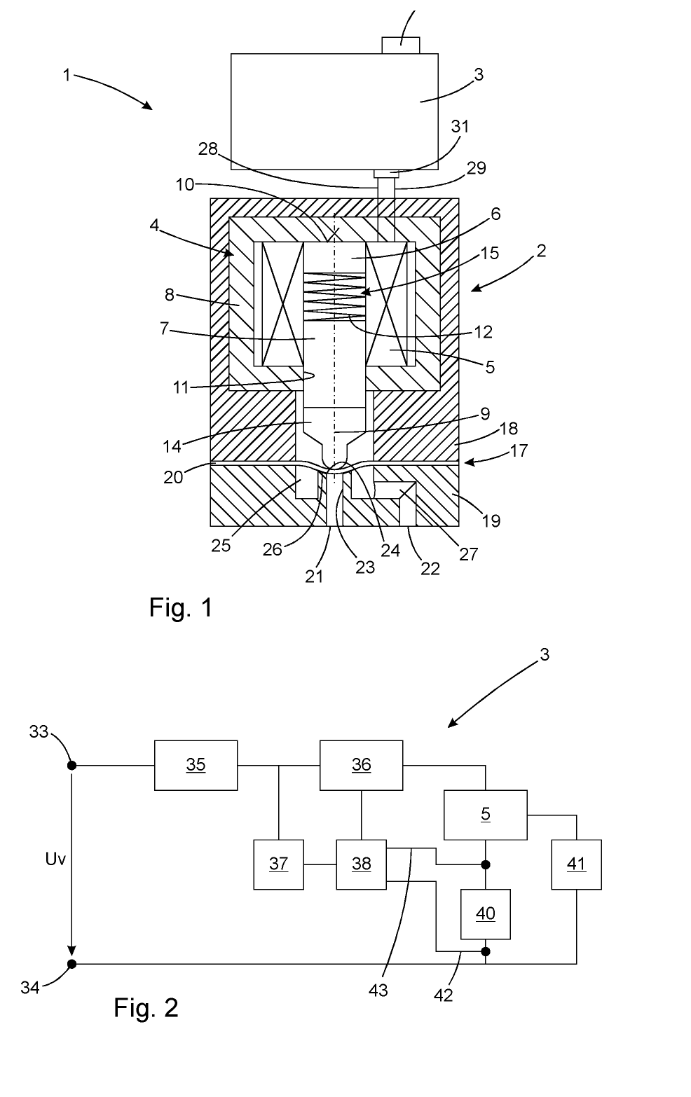

A solenoid valve system 1 shown in FIG. 1 comprises a solenoid valve 2 and a valve control 3 electrically connected to the solenoid valve 2. Purely by way of example, the solenoid valve 2 is designed as a diaphragm valve in which a flexible, in particular rubber-elastic, diaphragm 20 is sealingly arranged between a first valve housing part 18 and a second valve housing part 19 of a valve housing 17.

By way of example, a first fluid connection 21, also referred to as an inlet connection or input interface, and a second fluid connection 22, also referred to as an outlet connection or output interface, are formed on the valve housing 17. By way of example, it is provided that the first fluid connection 21 opens into a fluid channel 23, which is at least partially designed in the form of a sleeve and which has an opening 24 that opens into a valve chamber 25. The opening 24 is formed purely as an example on a circular end face 26 of the fluid channel 23 and is also referred to as a valve seat. The valve chamber 25 extends coaxially to the fluid channel 23 and is connected in a fluid-communicating manner to the second fluid connection 22 via a fluid line 21.

The diaphragm 20, made of a rubber-elastic material, is arranged adjacent to the circular end face 26 of the fluid channel 23 in such a way that it can be pressed sealingly against the circular end face 26 by elastic deformation. In order to achieve this sealing effect, the solenoid valve 2 is equipped with a solenoid drive 4. The solenoid drive 4 comprises a solenoid coil 5, a solenoid core 6, a movably mounted armature 7, and a yoke 8, which is shown here as a purely exemplary example with a rectangular profile. The solenoid coil 5 is exemplarily designed as an arrangement of a plurality of wire windings (not shown) which together form a circular cylindrical sleeve extending coaxially to a longitudinal axis 9. Furthermore, both the magnetic core 6 and the armature 7 are each designed to be rotationally symmetrical with respect to the longitudinal axis 9 and are made of a magnetic flux-conducting material. The magnetic core 6 is fixed in the magnetic coil 5, while the armature 7 is mounted in the magnetic coil 5 so that it can move linearly along the longitudinal axis 9.

A front side 10 of the magnetic core 6, which is facing away from the armature 7 and is, for example, flat, is in flat contact with the yoke 8 made of magnetic flux-conducting material. The yoke 8 surrounds the magnetic coil 5, is designed with a rectangular profile in the plane of FIG. 1, and is provided with a recess 11 designed coaxially with the longitudinal axis 9, which is penetrated by the armature 7. In order to give the armature 7 a preferred position, a spring 12 is arranged between the armature 7 and the magnetic core 6, in particular a helical spring, which has an internal preload and which presses a valve member 14, which is connected to the armature 7 in a purely exemplary manner, onto the diaphragm 20 when the solenoid coil 5 is de-energized, so that it bears sealingly against the circular end face 26.

In this rest position of the solenoid valve 2, also referred to as the first operating position, which can thus be described as normally closed, a fluidically communicating connection between the first fluid connection 21 and the second fluid connection 22 is interrupted.

In order to allow fluid to flow from the first fluid connection 21 to the second fluid connection 22 or in the opposite direction, it is necessary to remove the sealing effect between the diaphragm 20 and the circular end face 26 of the fluid channel 23, which serves as a valve seat. To this end, it is necessary to move the armature 7 from the first operating position shown in FIG. 1 to a second operating position not shown, in which the distance between the armature 7 and the magnetic core 6 is reduced and the spring device 12 is compressed. In order to cause this transfer of the armature 7, it is provided to supply a coil current from the valve control 3 to the magnetic coil 5 in order to thereby cause a magnetic flux in the magnetic core 6, in the yoke 8 and in the armature 7. Since the magnetic flux must overcome an air gap 15 between the armature 7 and the magnetic core 6, an attractive force arises between the armature 7 and the magnetic core 6. This attractive force causes elastic deformation of the spring device 12, thereby causing the armature 7 to move closer to the magnetic core 6 and the diaphragm 20 to lift off the circular end face 26.

To carry out this approach process between the armature 7 and the magnetic core 6, the valve control 3 is designed to supply a coil current to the solenoid coil 5 via an output interface 31 to which the connecting lines 28, 29 of the solenoid coil 5 are connected. The valve control 3 is supplied with power via an input interface 30, which is electrically connected to a higher-level control system (not shown).

A schematic diagram of the valve control 3 is shown in FIG. 2. It should be noted that an electrical supply voltage Uv is only provided between an input connection 33 and a ground connection 34 for the valve control 3 if the solenoid valve 2 is actually intended to be controlled, the input connection 33 and the ground connection 34 forming the input interface 30. At other times, it is not necessary to provide a supply voltage Uv to the valve control 3. In this respect, the supply voltage Uv provided at the input interface 30 also serves as a switching signal for actuating the solenoid valve system 1. In a non-illustrated embodiment of a valve control, a permanent supply of the supply voltage and a separate supply of a switching signal to the valve control are provided.

As can be seen from the illustration in FIG. 2, an input filter 35 is provided downstream of the input connection 33, the task of which is to attenuate or, preferably, completely eliminate interference emissions that can act on the valve control 3 from outside and interference emissions that can be caused by the valve control 3. A branch to a power stage 36 and a voltage supply module 37 is provided downstream of the input filter 35, wherein the power stage 36 may have one or more electrically controllable switches and wherein the voltage supply module 37 is designed to provide a stable supply voltage to a downstream microcontroller 38. The microcontroller 38 is electrically connected to the output stage 36 and provides control signals, in particular pulse width modulated control signals, to the output stage 36 in order to enable a current flow from the input connection 33 to the solenoid coil 5 of the solenoid valve 2, which is not shown in detail in FIG. 2, coupled to the output stage 36. The solenoid coil 5 is connected to the output stage 36 on the one hand and to the ground terminal 34 via a measuring resistor 40 on the other hand. This allows a current to flow from the input terminal 33 through the output stage 36, the solenoid coil 5, and the measuring resistor 40 to the output terminal 34 when a suitable control signal is provided by the microcontroller 38.

A free-wheeling diode 41 is arranged in parallel to the series connection of the magnetic coil 5 and the measuring resistor 40, which can divert the current occurring due to the counter-induction of the magnetic coil 2 when the power supply to the magnetic coil 5 is switched off.

The measuring resistor 40 is electrically connected to the microcontroller 38 via measuring lines 42, 43 and serves to detect a current-dependent voltage drop, which voltage drop can be determined by the microcontroller 38 and used as a measure of the current flow through the magnetic coil 5.

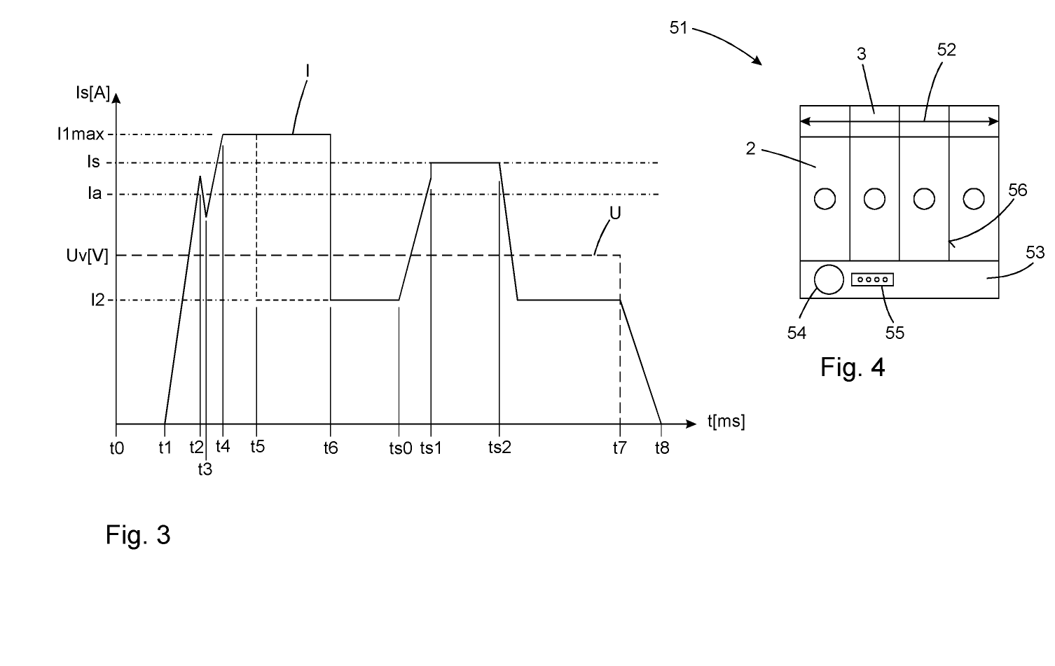

According to the illustration in FIG. 3, which shows a current-time diagram in which the course of the supply voltage Uv is also plotted, the supply voltage Uv is supplied at a time t0 and switched off again at a time t7.

Shortly after the supply voltage Uv is provided, a control signal is sent from the microcontroller 38 to the output stage 36 after the microcontroller 38 has been initialized. This results in the output stage 36 enabling a coil current at time t1, which is supplied to the magnetic coil 5. Time t1 thus represents the start of a first time period. Since the magnetic coil 5 counteracts an externally imposed current flow with its self-induction, the schematic and idealized representation in FIG. 3 shows a linear increase in the coil current between time t1 and time t2. At time t2, the magnetic flux in the air gap 15, as shown in FIG. 1, has increased to such an extent that the armature 7 overcomes the static friction against the yoke 8 and the magnetic coil 5 as well as the restoring force of the spring device 12 and starts to move toward the magnetic core 6.

This movement of the armature 7 in the magnetic coil 5 causes additional induction in the magnetic coil 5, which manifests itself in a current that is opposite to the current impressed on the magnetic coil 5. Accordingly, as shown in FIG. 3, from time t2 onwards, there is a temporary reduction in the coil current, which is also manifested in a decreasing voltage drop across the measuring resistor 40. This voltage drop is detected in the microcontroller 38 by comparing the currently measured voltage with voltages measured previously. For a current curve for the magnetic coil 5 calculated on the basis of the voltage drop determined at the measuring resistor 40, this results in a sign change for the slope of the current curve at time t2, where this sign change can be used as a trigger signal for the microcontroller 38 to provide current control for the solenoid valve 2 from time t5, which is also referred to as the end of the first time period and the beginning of a second time period.

As can be seen from the schematic representation in FIG. 3, the coil current initially drops from time t2 due to the relative movement of the armature 7 with respect to the solenoid coil 5 until the armature 7 reaches the second operating position at time t3, in which, contrary to the purely exemplary representation in FIG. 1, there is a minimal air gap 15 between the armature 7 and the magnetic core 6. From time t3, the coil current in the magnetic coil 5 rises again due to the armature 7 now coming to rest again until a maximum value I1max for the coil current I1, regulated by the microcontroller 38 serving as the controller, is reached at time t4.

In the event that the microcontroller 38 cannot detect the voltage drop at the measuring resistor 40, or at least cannot detect it reliably, a switchover takes place from the first coil current I1 to a reduced and constant coil current I2, also referred to as the holding current, at a point in time t6, which in this case defines the end of the first time period and the beginning of the second time period. This time point t6 can be permanently programmed into the microcontroller 38 and is selected so that the armature 7 has reached the second operating position with a high degree of reliability.

If, on the other hand, the microcontroller 38 can reliably determine the voltage drop across the measuring resistor 40 and thus the current flow through the magnetic coil 5, a switchover from the first coil current I1 to the reduced and constant second coil current I2 takes place at time t5, which is significantly earlier than time t6. For example, it is provided that there is a fixed time interval delta-t (=t5-t2) between time t2 and time t5, which is stored in the microcontroller 38. It is particularly advantageous if different time intervals delta-t are stored in the microcontroller 38 for different types of solenoid valves.

In the second time period, which begins either at time t5, provided that the microcontroller 38 can reliably detect the voltage drop across the measuring resistor 40 and thus the current flow through the solenoid coil 5, or which begins at time t6 if the microcontroller 38 cannot reliably determine the voltage drop across the measuring resistor 40 and thus the current flow through the solenoid coil 5, the microcontroller 38, which serves as a controller, supplies pulse-width-modulated drive signals to the output stage 36. This regulates the coil current to the holding current I2, which is a maximum of 70 percent of the maximum coil current I1max, also referred to as the pull-in current.

When the solenoid valve 2 is used as intended, external influences may cause the coil current in the solenoid coil 5 to increase during the second time period, which begins at the latest when time t6 elapses. Such external influences are, for example, mechanical acceleration of the solenoid valve 2, in which the valve element 14 is displaced relative to the solenoid coil 5 due to its inertia, or electrical actuation of an adjacent solenoid valve 2, as shown schematically in FIG. 4, whereby a magnetic flux is coupled from the solenoid coil of the adjacent solenoid valve 2 into the solenoid coil 5.

Such an increase in the coil current in the solenoid coil 5 causes the microcontroller 38 to intervene in the control, since the microcontroller 38 is designed to regulate the coil current to the specified holding current I2.

According to the invention, the microcontroller 38 is designed to perform this control intervention, which causes a brief reduction in the coil current, only if the previous increase in the coil current caused by the external influence has not led to a coil current exceeding a predetermined coil current threshold value Ia, as shown in FIG. 3.

If the increase in the coil current caused by the external influence causes the coil current to exceed the specified coil current threshold value Ia, the microcontroller 38 is designed to briefly increase the coil current to a safety current Is to ensure that the valve element 14 remains in the second operating position.

For illustrative purposes only, FIG. 3 shows that the coil current I rises abruptly at a point in time ts0 due to an external disturbance and shortly thereafter exceeds the coil current threshold value Ia. This is detected by the microcontroller 38 and causes the coil current to be increased further to the safety current Is at point in time ts1. At time ts2, the increase phase for the coil current ends, which is then reduced back to the previous holding current level I2 and maintained there until time t7.

According to the illustration in FIG. 4, in a valve arrangement 51, several solenoid valve systems 1 are arranged along a row axis 52 on a channel plate 53. It is intended that the solenoid valve systems 1 are arranged with their largest surfaces 56 adjacent to one another and that an interface (not shown) is formed on the channel plate 53 for each of the solenoid valve systems 1, at which both electrical signals and a gaseous fluid, in particular compressed air, are supplied to the solenoid valve systems 1. As can be seen from the schematic representation in FIG. 4, each of the solenoid valve systems 1 comprises a solenoid valve 2 and a valve control 3, which is shown purely as an example and is placed on top of the valve housing 17. A fluid connection 54 for supplying a gaseous fluid, in particular compressed air, to the solenoid valve systems 1 and an electrical connector 55 for supplying electrical signals to the solenoid valve systems 1 are formed on the channel plate 53. By way of example, it is provided that a first solenoid valve system 1 is supplied with electrical energy at a first point in time, thereby initiating the sequence shown in FIG. 3 for this first solenoid valve system. If, at a later point in time, a second solenoid valve system 1, in particular a second solenoid valve system 1 arranged immediately adjacent to the first solenoid valve system 1, is supplied with electrical energy, the electrical control of the second solenoid valve system 1 and the resulting change in magnetic flux for the second solenoid valve system 1 may influence the first solenoid valve system 1. If this influence on the first solenoid valve system 1 occurs at a time when the first time period, which extends at most up to time t6, has elapsed, this can cause an undesirable increase in the coil current in the first solenoid valve system 1. In order to prevent displacement of valve element 14 of the first solenoid valve system 1, the measures described in connection with FIG. 3 can be taken by the valve control 3 of the first solenoid valve system 1.

1. A valve control for controlling a solenoid valve, with a controller which has an input interface for receiving a switching signal and an output interface for supplying a solenoid valve, which controller processes the switching signal and supplies a coil current dependent on the switching signal to the output interface, wherein the controller regulates the coil current to an pull-in current during a first time period and regulates the coil current to a holding current which is less than 70 percent of the pull-in current during a subsequent second time period, wherein the controller performs a time-limited increase in the holding current by at least 20 percent during the second time period when a predetermined coil current threshold value is exceeded.

2. The valve control according to claim 1, wherein controller provides the time-limited increase in the holding current during a period of less than 0.5 seconds.

3. The valve control according to claim 1, wherein the controller is an analog electrical circuit with discrete components.

4. The valve control according to claim 1, wherein the controller comprises a microcontroller which is set up to carry out the control of the coil current during the first time period and during the second time period.

5. The valve control according to claim 4, wherein the controller is set up in such a way that the percentage increase for the holding current is determined during a parameterization of the controller in order to enable the at least one solenoid valve controlled by the valve control to be adapted to different operating conditions.

6. The valve arrangement with at least two solenoid valves and with at least one valve control according to claim 1, wherein each solenoid valve has a valve housing through which a fluid channel extends between an inlet connection and an outlet connection and in which a valve member is arranged in the fluid channel and is movable between a first operating position and a second operating position, wherein a solenoid drive is arranged in the valve housing, which is designed to initiate movement of the valve member and is electrically connected to the valve control.

7. The valve arrangement according to claim 6, wherein each of the solenoid valves is assigned a valve control.

8. The valve arrangement according to claim 6, wherein the solenoid valves are arranged adjacent to one another along a row axis.

9. The valve arrangement according to claim 6, wherein the solenoid valves are arranged on a common channel plate.

10. A method for operating a solenoid valve with the steps: controlling a coil current for a solenoid coil during a first time period to a first coil current level in order to provide a first magnetic flux to a valve member and thereby move the valve member from a first operating position to a second operating position, controlling the coil current for the solenoid coil during a second time period to a second coil current level which is at most 70 percent of the first coil current level in order to supply a second magnetic flux to the valve member and thereby to hold the valve member in the second operating position, monitoring the coil current supplied to the solenoid coil supplied to the solenoid coil during the second time period to exceed a predetermined solenoid coil current threshold value and performing a time-limited increase of the second solenoid coil current level by at least 20 percent when the predetermined solenoid coil current threshold value is exceeded.

11. The method according to claim 10, wherein the temporary increase in the holding current is carried out during a period of less than 0.5 seconds.

12. The method according to claim 10, comprising the step of a parameterization to determine a percentage increase for a holding current that is supplied to the solenoid valve when a predetermined coil current threshold value is exceeded; before the coil current is provided to the solenoid coil.
